(19) United States
(12) Patent Application Publication
(10) Pub. No.: US 2018/0285751 A1
(43) Pub. Date: Oct. 4, 2018

(54) SIZE DATA INFERENCE MODEL BASED ON MACHINE-LEARNING

(71) Applicant: LinkedIn Corporation, Sunnyvale, CA (US)

(72) Inventors: Marcello Oliva, New York, NY (US); Rajan Ramesh Chaudhari, San Francisco, CA (US); Aaron Tyler Rucker, San Francisco, CA (US)

(21) Appl. No.: 15/477,860

(22) Filed: Apr. 3, 2017

(51) Int. Cl. G06N 5/04; G06F 17/30; G06N 99/00

(52) U.S. Cl. CPC G06N 5/04; G06N 99/005; G06F 17/30864

(57) ABSTRACT

Techniques for inferring data are disclosed herein. In some embodiments, a data inference system detects a lack of size data for a profile of an organization on an online service, with the size data identifying a size of the organization, generates the size data based on an inference model and at least two attributes of the organization, and performs a function of the online service using the generated size data. In some embodiments, the data inference system retrieves instances of attributes for a plurality of organization profiles on the online service, generates a predicted size data using the inference model for each one of the plurality of organization profiles, retrieves a control size data for each one of the plurality of organization profiles, and uses a machine learning algorithm to modify the inference model based on a comparison of the corresponding predicted size data with the corresponding control size data.

### TECHNICAL FIELD

The present application relates generally to information retrieval and, in one specific example, to methods and systems of inferring data.

### BACKGROUND

Online services, such as social networking services, often suffer from a lack of data for certain documents, profiles, or other entities. This lack of data can cause technical problems in the performance of the online service. For example, in situations where the online service is performing a search based on search criteria for a certain type of data, entities are often omitted from the search because of their lack of that type of data even though they would have satisfied the search criteria if someone had included the corresponding data for those entities. As a result, the accuracy and completeness of the search results are diminished. Other technical problems from such omissions can arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a data inference system, in accordance with an example embodiment.

FIG. 4 illustrates a graphical user interface (GUI) displaying a profile of an organization on an online service, in accordance with an example embodiment.

FIG. 5 is a flowchart illustrating a method of inferring data, in accordance with an example embodiment.

FIG. 6 is a flowchart illustrating a method of modifying an inference model, in accordance with an example embodiment.

FIG. 7 is a flowchart illustrating a method of performing a function of an online service using generated data, in accordance with an example embodiment.

FIG. 8 is a flowchart illustrating a method of modifying an inference model, in accordance with an example embodiment.

FIG. 9 illustrates a GUI displaying a verification request, in accordance with an example embodiment.

FIG. 10 is a block diagram illustrating a mobile device, in accordance with some example embodiments.

FIG. 11 is a block diagram of an example computer system on which methodologies described herein may be executed, in accordance with an example embodiment.

### DETAILED DESCRIPTION

Example methods and systems of inferring data are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure provides example embodiments in which size data for a profile of an organization on an online service is inferred. However, it is contemplated that the techniques of the present disclosure can also be used to infer other types of data as well.

In some example embodiments, operations are performed by a machine having a memory and at least one hardware processor, with the operations comprising: detecting a lack of size data for a profile of an organization on an online service, with the size data identifying a size of the organization; based on the detecting of the lack of size data for the profile of the organization, generating the size data based on an inference model and at least two attributes of the organization; and performing a function of the online service using the generated size data.

In some example embodiments, the operations further comprise: retrieving instances of attributes for a plurality of organization profiles on the online service; for each one of the plurality of organization profiles, generating a predicted size data using the inference model; for each one of the plurality of organization profiles, retrieving a control size data; and using a machine learning algorithm to modify the inference model based on a comparison of the corresponding predicted size data of the plurality of organization profiles with the corresponding control size data of the plurality of organization profiles.

In some example embodiments, the size data comprises a classification of a total number of members of the organization.

In some example embodiments, the at least two attributes comprise at least two features from a group of features consisting of an indication of a data ingestion method of the organization, data indicating a total number of members of the online service mapped to the profile of the organization, location data of the organization, an industry type of the organization, an organization type, data indicating a level of user engagement with the profile of the organization, an advertising metric, an indication of whether the organization has an account with another online service, and data indicating an age of the organization.

In some example embodiments, the performing the function of the online service using the generated size data comprises storing, in a database, the generated size data in association with the profile of the organization.

In some example embodiments, the performing the function of the online service using the generated size data comprises searching the online service for profiles of organizations that satisfy a search criteria including at least a size criteria, the searching comprising determining whether the generated size data satisfies the size criteria of the search criteria. In some example embodiments, the operations further comprise receiving a search request including the search criteria, wherein the generating of the size data and the searching of the online service are performed based on the receiving of the search request.

In some example embodiments, the operations further comprise: transmitting a verification request to a computing device of a user associated with the organization, the verification request comprising the generated size data and a request for feedback regarding accuracy of the generated size data; receiving, from the computing device, feedback regarding the accuracy of the generated size data; and modifying the inference model based on the received feedback.

In some example embodiments, the online service comprises a social networking service.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

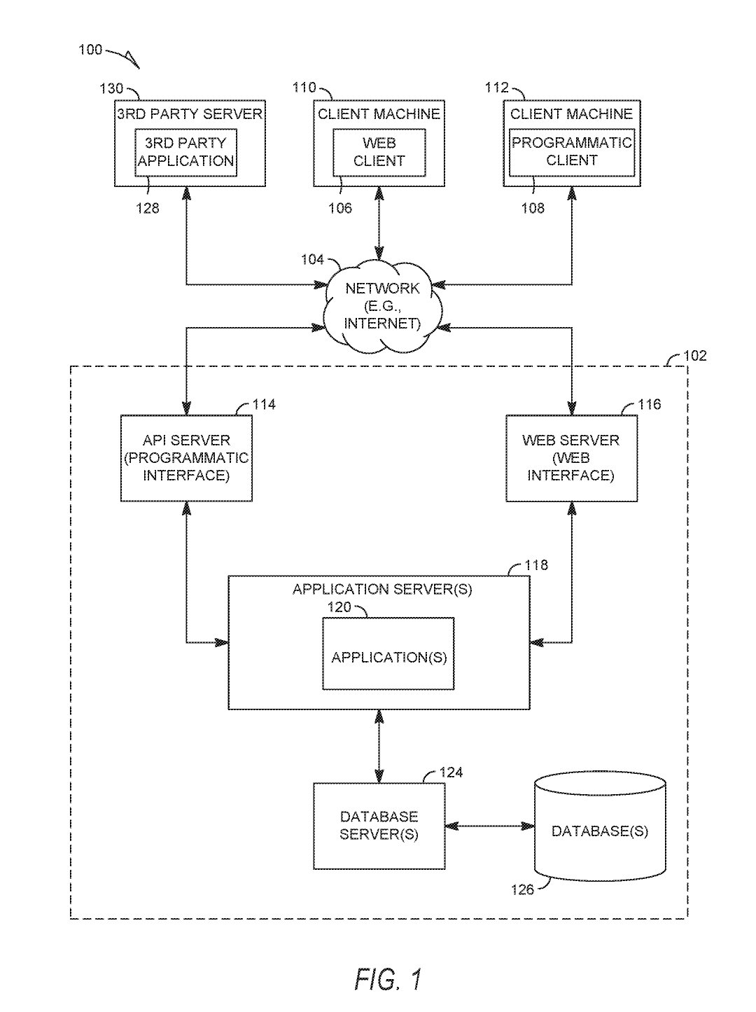

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

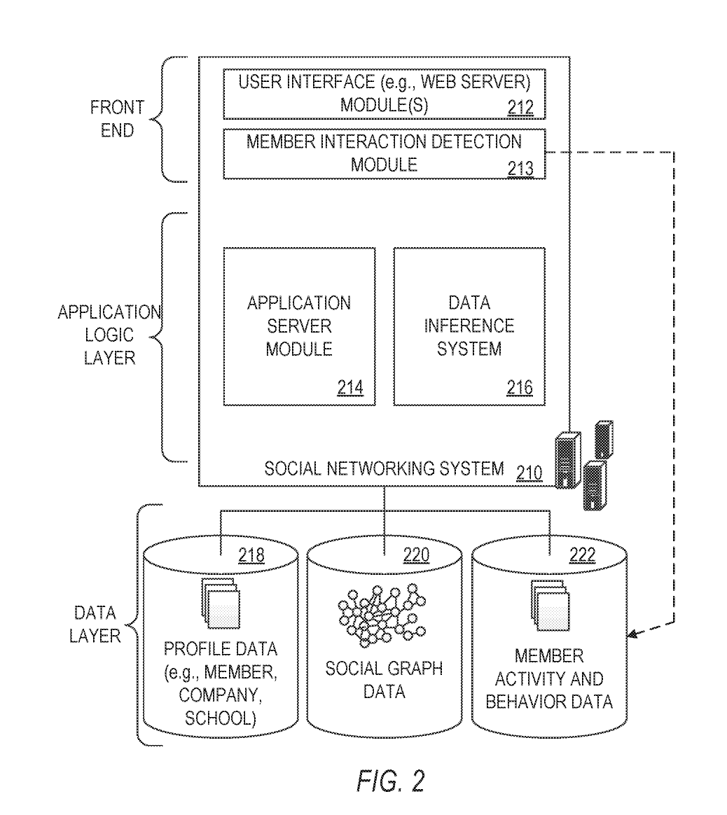

In some embodiments, the networked system 102 may comprise functional components of a social networking service. FIG. 2 is a block diagram showing the functional components of a social networking system 210, including a data processing module referred to herein as an data inference system 216, for use in social networking system 210, consistent with some embodiments of the present disclosure. In some embodiments, the data inference system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the data. inference system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the data inference system 216.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the data inference system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

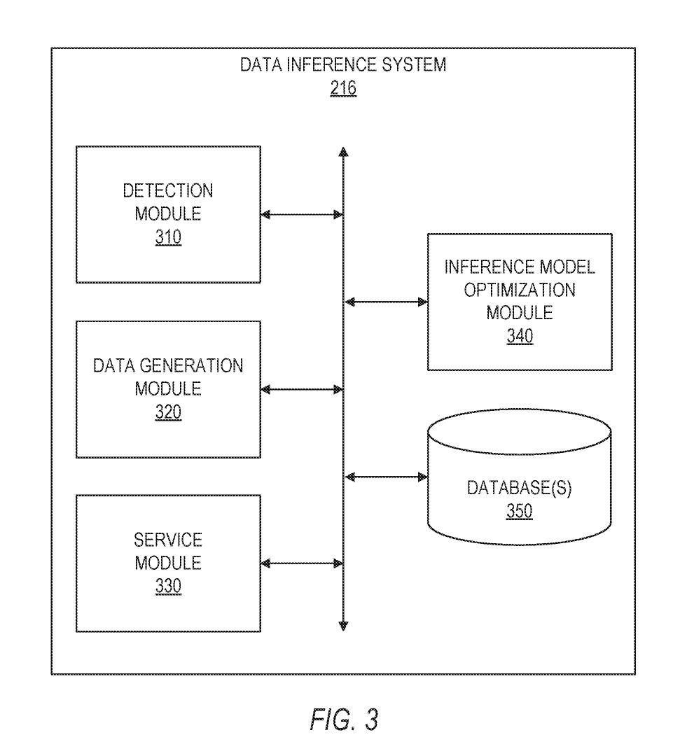

FIG. 3 is a block diagram illustrating components of the data inference system 216, in accordance with an example embodiment. In some embodiments, the data inference system 216 comprises any combination of one or more of a detection module 310, a data generation module 320, a service module 330, an inference model optimization module 340, and one or more database(s) 350. The detection module 310, the data generation module 320, the service module 330, the inference model optimization module 340, and the database(s) 350 can reside on a machine having a memory and at least one processor (not shown). In some embodiments, the detection module 310, the data generation module 320, the service module 330, the inference model optimization module 340, and the database(s) 350 can be incorporated into the application server(s) 118 in FIG. 1. In some example embodiments, the database(s) 350 is incorporated into database(s) 126 in FIG. 1 and can include any combination of one or more of databases 218, 220, and 222 in FIG. 2. However, it is contemplated that other configurations of the modules 310, 320, 330, and 340, as well as the database(s) 350, are also within the scope of the present disclosure.

In some example embodiments, one or more of the detection module 310, the data generation module 320, the service module 330, and the inference model optimization module 340 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the detection module 310, the data generation module 320, the service module 330, and the inference model optimization module 340 is configured to receive user input. For example, one or more of the modules 310, 320, 330, and 340 can present one or more GUI elements (e.g., drop-down menu, selectable buttons, text field) with which a user can submit input.

In some example embodiments, one or more of the modules 310, 320, 330 and 340 is configured to perform various communication functions to facilitate the functionality described herein, such as by communicating with the social networking system 210 via the network 104 using a wired or wireless connection. Any combination of one or more of the modules 310, 320, 330, and 340 may also provide various web services or functions, such as retrieving information from the third party servers 130 and the social networking system 210. Information retrieved by the any of the modules 310, 320, 330, and 340 may include profile data corresponding to users and members of the social networking service of the social networking system 210.

Additionally, any combination of one or more of the modules 310, 320, 330, and 340 can provide various data functionality, such as exchanging information with database(s) 350 or servers. For example, any of the modules 310, 320, 330, and 340 can access member profiles that include profile data from the database(s) 350, as well as extract attributes and/or characteristics from the profile data of member profiles. Furthermore, the one or more of the modules 310, 320, 330, and 340 can access social graph data and member activity and behavior data from database(s) 350, as well as exchange information with third party servers 130, client machines 110, 112, and other sources of information.

In some example embodiments, the detection module 310 is configured to detect a lack of size data for a profile of an organization on an online service. The size data identifies a size of the organization. In some example embodiments, the size data comprises a classification or other indication of the total number of members of the organization. One example of an organization is a company, and the size data may comprise a classification or other indication of the total number of employees of the company. It is contemplated that other types of organizations and members are also within the scope of the present disclosure.

In some example embodiments, the size data may comprise an exact number of employees (e.g., 4,503 employees), a number range of employees (e.g., 1,001-5,000 employees), or some other size classification (e.g., small, medium, big) In some example embodiments, the online service comprises a social networking service. However, it is contemplated that other types of online services are also within the scope of the present disclosure. For example, external search engines (e.g., a search engine separate and independent from any search engine of the social networking service on which the data inference system is employed 216) may benefit from having access to size data that otherwise would be missing or inaccurate, such as by making the search results of those external search engines more accurate, relevant, and complete.

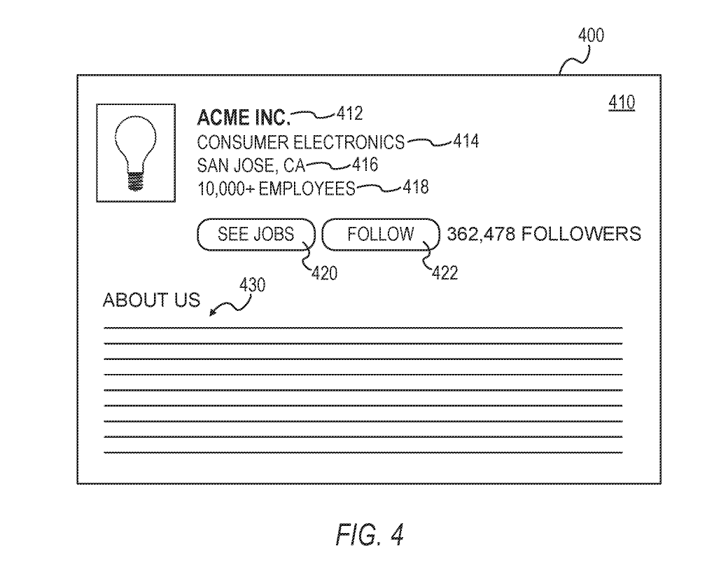

FIG. 4 illustrates a graphical user interface (GUI) 400 displaying a profile 410 of an organization on an online service, in accordance with an example embodiment. As seen in FIG. 4, the profile 410 may comprise a variety of different data associated with the organization, such as the name (or other identifier) 412 of the organization (e.g., “ACME INC.”), an industry 414 of the organization (e.g., “CONSUMER ELECTRONICS”), a geographic location 416 of the organization (e.g., “SAN JOSE, CA”), and a size 418 of the organization (e.g., “10,000+ EMPLOYEES”). The profile 410 may also comprise links configured to perform certain functions when activated, such as a link 420 configured to trigger a display of available jobs with the organization, and a link 422 configured to enable a user viewing the profile 410 of the organization to follow the organization. It is contemplated that other types of links are also within the scope of the present disclosure. The profile 410 may also include additional information related to the organization, such as a description 430 of the organization.

It is contemplated that the detection module 310 may detect the lack of size data for a profile in a variety of ways. In some example embodiments, the detection module 310 periodically scans all of the profiles on the online service to find any profiles having a corresponding field for size data that is lacking any data (e.g., the field is blank) or that is lacking any appropriate data from which a size can be determined (e.g., the field comprises a meaningless set of one or more characters that do not indicate a size, such as “3X&m3y”).

In some example embodiments, the detection module 310 detects that a profile is lacking size data when that profile is being used or is going to be used in a function of the online service for which the size data is necessary or otherwise relevant. For example, as a search for profiles satisfying a particular criteria is performed, the detection module 310 may inspect each profile to determine whether or not is comprises sufficient size data.

In some example embodiments, the data generation module 320 is configured to generate the size data for an organization based on an inference model and at least two attributes of the organization in response to, or otherwise based on, the detection of the lack of size data for the profile of the organization. The data generation module 320 may retrieve the attributes from the profile of the organization, or from some other source, and input the retrieved attributes into the inference model, which may then generate and output size data. The data generation module 320 may then store the generated size data in database(s) 350 in association with the profile of the organization (e.g., in profile database 218 in FIG. 2).

It is contemplated that the attributes used by the data generation module 320 to generate the size data may comprise a variety of different feature data related to the organization. In some example embodiments, the at least two attributes comprise at least two features from a group of features consisting of an indication of a data ingestion method of the organization, data indicating a total number of members of the online service mapped to the profile of the organization, location data of the organization, an industry type of the organization, an organization type, data indicating a level of user engagement with the profile of the organization, an advertising metric, an indication of whether the organization has an account with another online service, data indicating an age of the organization, organization relationship data, organization-specific attributes, explicit member actions, implicit member actions, and actions by the organization. However, it is contemplated that other feature data can also be used as the attributes used by the data generation module 320 to generate the size data.

In some example embodiments, a data ingestion method of the organization includes, but is not limited to, the process used by the organization to obtain and import data. For example, data may be ingested organically by an administrator of the organization simply inputting the data, or data may be ingested using a service of another entity to automatically retrieve and import the data.

In some example embodiments, data indicating a total number of members of the online service mapped to the profile of the organization includes, but is not limited to, the total number of members of the online service that are connected to the organization, a total number of members of the online service that are in the same industry or region/country as the organization, and/or a percentage change in the total number of members of the online service that are mapped or connected to the organization for a specified period of time.

In some example embodiments, location data of the organization includes, but is not limited to, a region and/or country of the organization (e.g., where the organization resides).

In some example embodiments, an industry type of the organization includes, but is not limited to, an identification of what industry the organization belongs to (e.g., consumer electronics).

In some example embodiments, an organization type of the organization includes, but is not limited to, an indication of the nature of the organization, such as a non-profit, a partnership, an educational organization, a self-owned organization, a governmental agency, and/or a public company.

In some example embodiments, data indicating a level of user engagement with the profile of the organization includes, but is not limited to, a total number of views of a page of the organization on the online service for a specified period of time (e.g., the last 90 days), a total number of clicks on a page of the organization on the online service for a specified period of time, a total number of shares of a page of the organization on the online service for a specified period of time, a total number of likes of a page of the organization on the online service for a specified period of time, a total number of comments on a page of the organization on the online service or of comments related to the organization on the online service (e.g., comments that mention the organization) for a specified period of time, a total number of followers of a page of the organization on the online service for a specified period of time, and/or a total number of contributors to a page of the organization on the online service for a specified period of time.

In some example embodiments, the advertising metric includes, but is not limited to, average revenue generated by members of the online service that are mapped to the organization for a specified period of time, and/or an average number of campaigns mapped members of the organization clicked on within a specified period of time.

In some example embodiments, the indication of whether the organization has an account with another online service includes, but is not limited to, an indication of whether the organization has an account with a customer relationship management service (e.g., Salesforce).

In some example embodiments, the data indicating an age of the organization includes, but it not limited to, the year the organization was founded, and/or the earliest year associated with a member of the online service that is mapped to the organization.

In some example embodiments, the organization relationship data includes, but is not limited to, data indicating whether the organization has a parent company or any subsidiary companies, as well as the total number of organizations the organization has a relationship with.

In some example embodiments, the organization-specific attributes include, but are not limited to, a number of administrators the organization has for its profile on a social networking service, whether the organization has a career page on a social networking service, whether the organization has a stock symbol (e.g., whether or not the organization is a publicly traded company), and the number of locations or offices the organization has.

In some example embodiment, the explicit member actions include, but are not limited to, the number of followers of the organization on a social networking service (e.g., the number of members that clicked on a “follow” button).

In some example embodiments, the implicit member actions include, but are not limited to, the number of page views of the organization's page on a social networking service (e.g., the number of members that visited the page).

In some example embodiments, the actions by the organization include, but are not limited to, the number of jobs posted (e.g., on a social networking service) by the organization.

In some example embodiments, feature data may be adjusted based on market penetration of the organization by country. For example, one-thousand followers may have a different weight whether the organization is in the United States, where the organization has 95% penetration) or in Japan, where the organization has 5% penetration.

In some example embodiments, the detection module 310 is configured to determine that size data for a profile of an organization on an online service is potentially incorrect, even though a valid size data exists for the profile of the organization. For example, the current size data for the profile of the organization may be outdated and, therefore, not reflect recent hiring or layoff rounds of the organization. In some example embodiments, the detection module 310 is configured to detect that the current size data for the profile is outdated based on an analysis of date (or other time data) of the last time the current size data was set or updated. The detection module 310 may signal the data generation module 320 to generate size data for the organization based on an inference model and at least two attributes of the organization in response to, or otherwise based on, a determination that the amount of time since the current size data for the profile of the organization was last updated exceeds, or otherwise satisfies, a predetermined threshold amount of time (e.g., if it has been more than 1 year since the current size data for the profile of the organization was updated).

In another example, the current size data may include part-time workers, consultants, alumni, or other categories of people involved with the organization that should not be considered members of the organization for the purposes of calculating the size of the organization. In some example embodiments, the detection module 310 is configured to detect that the current size data for the profile includes one or more categories of people involved with the organization that should not be included in the size data based on an analysis of the profiles of people associated with the organization. The detection module 310 may signal the data generation module 320 to generate size data for the organization based on an inference model and at least two attributes of the organization in response to, or otherwise based on, a determination that the current size data for the profile includes one or more categories of people involved with the organization that should not be included in the size data.

In yet another example, the current size data may have been intentionally set to a higher value than the true size of the organization by an administrator of the organization in order to increase the credibility, popularity, or other opinion of the organization, or the current size data may have been mistakenly set to a higher or lower value than the true value. In some example embodiments, the detection module 310 is configured to detect that current size data may have been intentionally or mistakenly set to an unacceptably different value than the true size of the organization based on a comparison of attributes of the organization with a set of one or more rules configured to flag candidates for further processing and scrutiny by the data generation module 320. For example, the detection module 310 may scan a plurality of organization profiles, analyzing one or more attributes of those organization profiles to determine if the current size data for each organization profile matches a reference size data that corresponds to the analysed attribute(s) of the organization profile. If it is determined by the detection module 310 that the current size data does not match the reference size data, then the detection module 310 may signal the data generation module 320 to generate size data for the organization based on an inference model and at least two attributes of the organization.

In some example embodiments, the data generation module 520 is also configured to generate other data based on the generated size data. For example, in some example embodiments, the data generation module 520 is further configured to generate revenue data (e.g., how much revenue a company earns) based on the generated size data and another inference model.

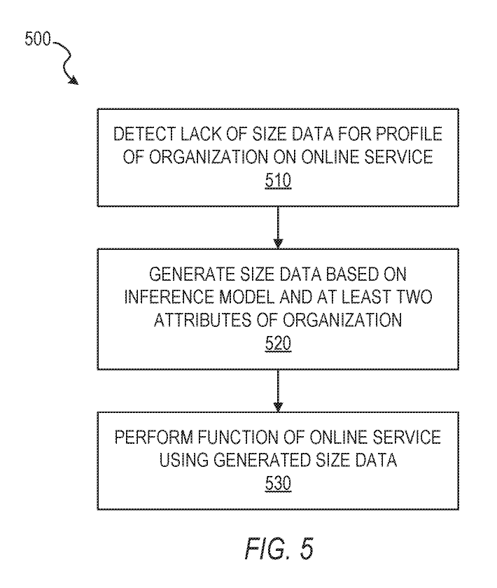

FIG. 5 is a flowchart illustrating a method 500 of inferring data, in accordance with an example embodiment. Method 500 can be performed by processing logic that can comprise hardware (e.g., circuitry, dedicated logic, programmable logic, microcode, etc.), software (e.g., instructions run on a processing device), or a combination thereof. In one implementation, the method 500 is performed by the data inference system 216 of FIGS. 2-3, or any combination of one or more of its modules, as described above.

At operation 510, the data inference system 216 detects a lack of size data for a profile of an organization on an online service, with the size data identifying a size of the organization. At operation 520, based on the detecting of the lack of size data for the profile of the organization, the data inference system 216 generates the size data based on an inference model and at least two attributes of the organization. At operation 530, the data inference system 216 performs a function of the online service using the generated size data.

It is contemplated that any of the other features described within the present disclosure can be incorporated into method 500.

Referring back to FIG. 3, in some example embodiments, the inference model optimization module 340 is configured to use one or more machine learning algorithms to modify the inference model. In this way, the inference model optimization module 340 can determine the best attributes to use in the determination of the size data for an organization, as well as the best way to use those attributes (e.g., how to weight the attributes in the inference model).

In some example embodiments, the inference model optimization module 340 is configured to retrieve instances of attributes for a plurality of organization profiles on the online service, and, for each one of the plurality of organization profiles, generate a predicted size data using the inference model. In some example embodiments, the inference model optimization module 340 is further configured to, for each one of the plurality of organization profiles, retrieve a control size data, and use a machine learning algorithm to modify the inference model based on a comparison of the corresponding predicted size data of the plurality of organization profiles with the corresponding control size data of the plurality of organization profiles. The control size data comprises size data that is determined to be accurate for the organization and therefore serves as a reference for determining the accuracy level of the predicted size data, which is consequently used in determining the accuracy level of the inference model used to generate the predicted size data. Through this optimization process, the inference model optimization module 340 can increase the accuracy of the inference model, resulting in more accurate size data generated by the data generation module 320.

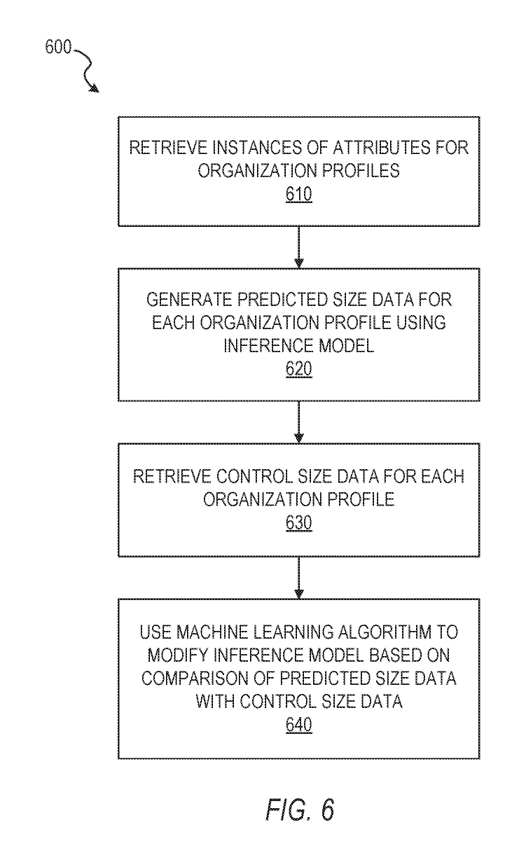

FIG. 6 is a flowchart illustrating a method 600 of modifying an inference model, in accordance with an example embodiment. Method 600 can be performed by processing logic that can comprise hardware (e.g., circuitry, dedicated logic, programmable logic, microcode, etc.), software (e.g., instructions run on a processing device), or a combination thereof. In one implementation, the method 600 is performed by the data inference system 216 of FIGS. 2-3, or any combination of one or more of its modules, as described above.

At operation 610, the data inference system 216 retrieves instances of attributes for a plurality of organization profiles on the online service. At operation 620, the data inference system 216, for each one of the plurality of organization profiles, generates a predicted size data using the inference model. At operation 630, the data inference system 216, for each one of the plurality of organization profiles, retrieves a control size data. At operation 640, the data inference system 216 uses a machine learning algorithm to modify the inference model based on a comparison of the corresponding predicted size data of the plurality of organization profiles with the corresponding control size data of the plurality of organization profiles.

It is contemplated that any of the other features described within the present disclosure can be incorporated into method 600.

Referring back to FIG. 3, in some example embodiments, the service module 330 is configured to perform one or more functions of the online service using the size data generated by the data generation module 320. One example of performing a function of the online service using the size data generated by the data generation module 320 is storing, in a database, the generated size data in association with the profile of the organization. As a result of this storing of the generated size data, such generated size data becomes available for display on a profile page of the organization, such as in profile 410 in FIG. 4. For example, instead of the size 418 of the organization being absent from the profile 410, as might otherwise be the case without the data inference features disclosed herein, the size 418 of the organization may be displayed on the profile page. Other features and functions of the online service can also access the generated size data stored in the database.

Another example of performing a function of the online service using the size data generated by the data generation module 320 is performing a search of profiles using a search criteria that includes a size criteria. In some example embodiments, the detection module 310 detects the lack of size data and the data generation module 320 generates the size data prior to a search request being serviced using the generated size data. However, in other example embodiments, a search request comprising the search criteria is received, and then the detection module 310 detects the lack of size data and the data generation module 320 generates the size data, which is then used in servicing the search request, such as determining whether the organization for which the size data is generated satisfies the size criteria of the search request. In this respect, the data inference system 216 can generate size data for an organization that lacks such size data in its profile in real-time, rather than relying on a periodic maintenance process. As a result, the generated size data may be more up-to-date, and therefore more accurate, and the computational expense involved with performing frequent periodic maintenance operations that involve analyzing profiles can significantly reduced.

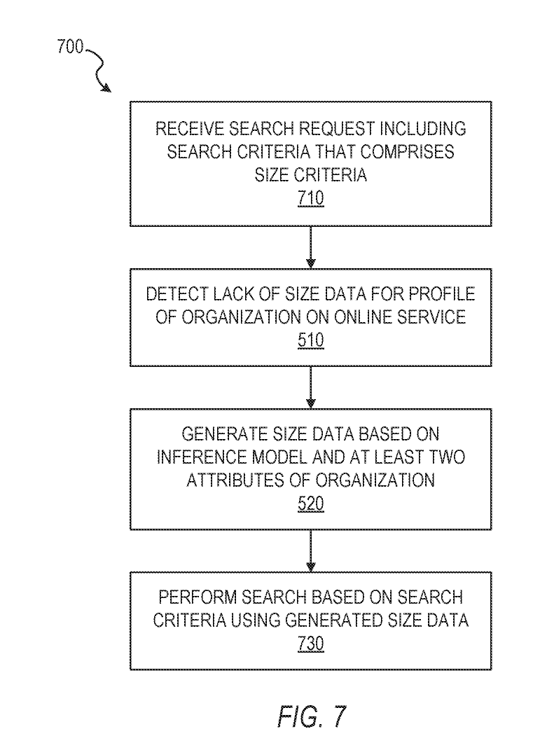

FIG. 7 is a flowchart illustrating a method 700 of performing a function of an online service using generated data, in accordance with an example embodiment. Method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the data inference system 216 of FIGS. 2-3, or any combination of one or more of its modules, as described above.

At operation 710, the data inference system 216 receives a search request including search criteria that includes at least a size criteria. The method 700 then proceeds to operation 510, where the data inference system 216 detects a lack of size data for a profile of an organization on an online service. At operation 520, based on the detecting of the lack of size data for the profile of the organization, the data inference system 216 generates the size data based on an inference model and at least two attributes of the organization. At operation 730, the data inference system 216 performs a search based on the search criteria using the generated size data. The data inference system 216 searches the online service for profiles of organizations that satisfy the search criteria, including the size criteria. The performance of the search includes determining whether the generated size data of organizations satisfies the size criteria of the search criteria.

It is contemplated that any of the other features described within the present disclosure can be incorporated into method 700.

Referring back to FIG. 3, in some example embodiments, the inference model optimization module 340 is further configured to modify the inference model based on feedback from a user regarding the accuracy of size data generated by the data generation module 320. For example, the inference model optimization module 340 may transmit a verification request to a computing device of a user associated with the organization (e.g., an administrator of the organization).

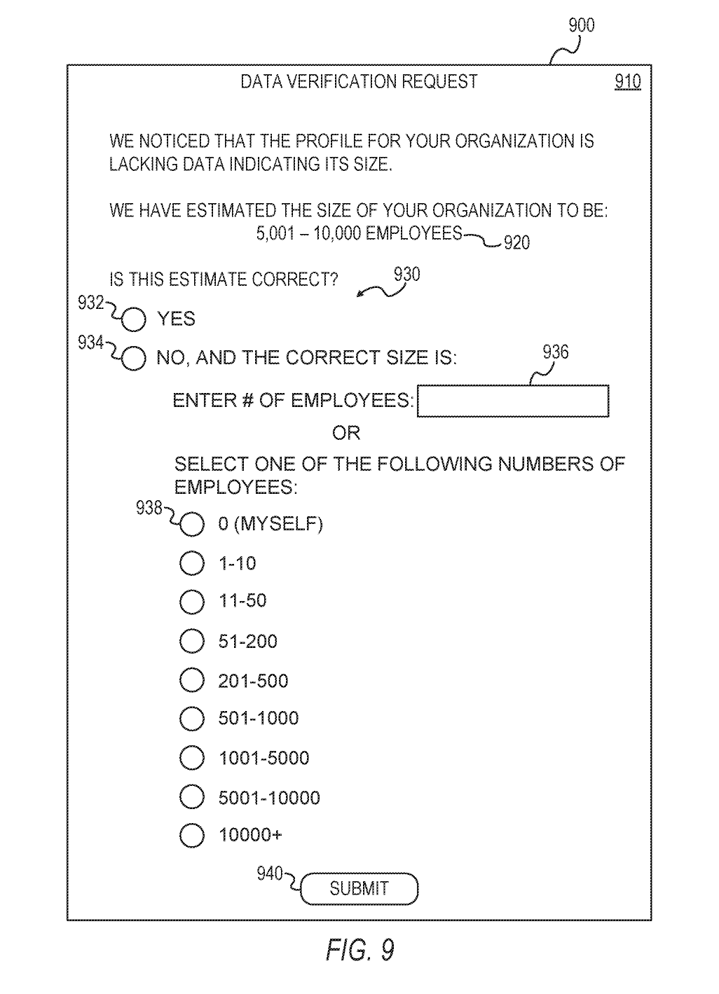

FIG. 9 illustrates a GUI 900 displaying a verification request 910, in accordance with an example embodiment. The verification request 910 may be transmitted to the user via e-mail, text message, a web page of the online service, push notification, and/or within a mobile application of the online service. Other ways of presenting the verification request 910 to the user are also within the scope of the present disclosure.

In some example embodiments, the verification request 910 comprises size data 920 generated by the data generation module 320 (e.g., “5,001-10,000 EMPLOYEES” in FIG. 9) and a request 930 for feedback regarding accuracy of the generated size data 920 (e.g., “IS THIS ESTIMATE CORRECT?” in FIG. 9). The verification request 910 may comprise one or more graphic user interface elements configured to be used by a recipient of the verification request 910 to provide feedback regarding the accuracy of the generated size data 920. For example, the verification request 910 may comprise selectable radio buttons 932 and 934 configured to enable the recipient to indicate whether or not the generated size data 920 is correct, as well as a text field 936 configured to receive input from the recipient indicating correct size data that should be used by the online service and the data inference system 216 instead of the generated size data 920. Additionally or alternatively, the verification request 910 may comprise a plurality of selectable radio buttons 938 configured to enable the user to select the correct range, or other classification, of the total number of members of the organization that should be used by the online service and the data inference system 216 instead of the generated size data 920. A selectable “SUBMIT” button 940 may be provided in the verification request to enable the user to submit the feedback regarding the accuracy of the generated size data 920.

In some example embodiments, the inference model optimization module 340 is further configured to receive the feedback regarding the accuracy of the generated size data from the computing device of the user, and then modify the inference model based on the received feedback. For example, the degree of error between the generated size data and the correct size data indicated in feedback from the user can be used by the inference model optimization module 340 to analyze the accuracy of the inference model. The inference model optimization module 340 may accumulate feedback from several different users regarding several different generated size data for different organizations. The analysis of such accumulated feedback may be used by the inference model optimization module 340 to change the attributes used in the inference model or the way in which the attributes are used (e.g., the weighting of the attributes)

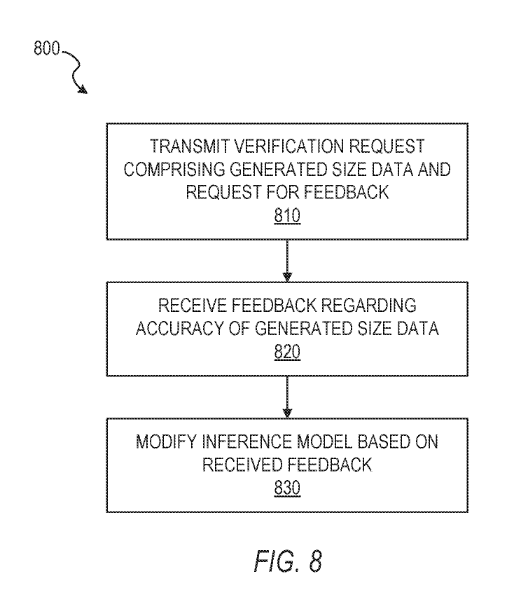

FIG. 8 is a flowchart illustrating a method 800 of modifying an inference model, in accordance with an example embodiment. Method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the data inference system 216 of FIGS. 2-3, or any combination of one or more of its modules, as described above.

At operation 810, the data inference system 216 transmits a verification request to a computing device of a user associated with the organization, with the verification request comprising the generated size data and a request for feedback regarding accuracy of the generated size data. At operation 820, the data inference system 216 receives, from the computing device, feedback regarding the accuracy of the generated size data. At operation 830, the data inference system 216 modifies the inference model based on the received feedback.

It is contemplated that any of the other features described within the present disclosure can be incorporated into method 800.

### Example Mobile Device

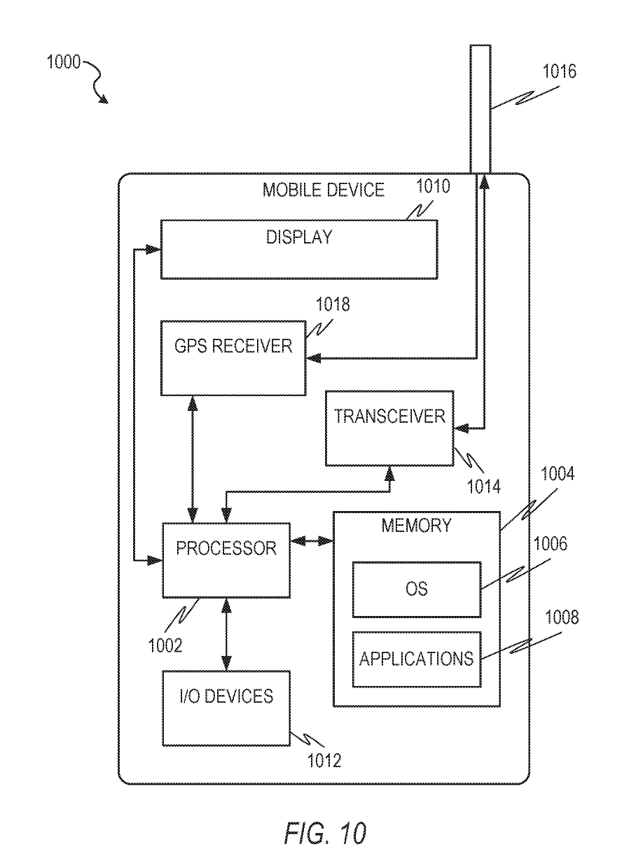

FIG. 10 is a block diagram illustrating a mobile device 1000, according to an example embodiment. The mobile device 1000 can include a processor 1002. The processor 1002 can be any of a variety of different types of commercially available processors suitable for mobile devices 1000 (for example, an XScale architecture microprocessor, a Microprocessor without Interlocked Pipeline Stages (MIPS) architecture processor, or another type of processor). A memory 1004, such as a random access memory (RAM), a Flash memory, or other type of memory, is typically accessible to the processor 1002. The memory 1004 can be adapted to store an operating system (OS) 1006, as well as application programs 1008, such as a mobile location-enabled application that can provide location-based services (LBSs) to a user. The processor 1002 can be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 can be coupled to a transceiver 1014 that interfaces with an antenna 1016. The transceiver 1014 can be configured to both transmit and receive cellular network signals, wireless data signals, or other types of signals via the antenna 1016, depending on the nature of the mobile device 1000. Further, in some configurations, a GPS receiver 1018 can also make use of the antenna 1016 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

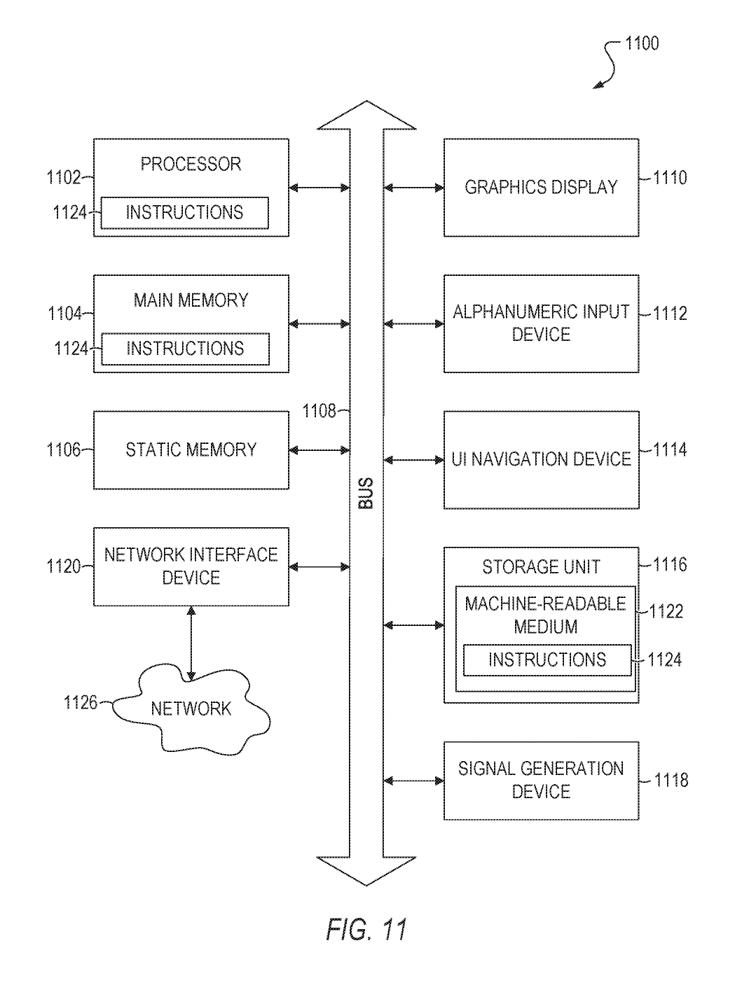

FIG. 11 is a block diagram of an example computer system 1100 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a graphics display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation device 1114 (e.g., a mouse), a storage unit 1116, a signal generation device 1118 (e.g., a speaker) and a network interface device 1120.

### Machine-Readable Medium

The storage unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions (e.g., instructions 1124) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
detecting, by at least one hardware processor, a lack of size data for a profile of an organization on an online service, the size data identifying a size of the organization;
based on the detecting of the lack of size data for the profile of the organization, generating, by the at least one hardware processor, the size data based on an inference model and at least two attributes of the organization;
performing, by the at least one hardware processor, a function of the online service using the generated size data;
retrieving, by the at least one hardware processor, instances of attributes for a plurality of organization profiles on the online service;
for each one of the plurality of organization profiles, generating, by the at least one hardware processor, a predicted size data using the inference model;
for each one of the plurality of organization profiles, retrieving, by the at least one hardware processor, a control size data; and
using, by the at least one hardware processor, a machine learning algorithm to modify the inference model based on a comparison of the corresponding predicted size data of the plurality of organization profiles with the corresponding control size data of the plurality of organization profiles.

2. The computer-implemented method of claim 1, wherein the size data comprises a classification of a total number of members of the organization.

3. The computer-implemented method of claim 1, wherein the at least two attributes comprise at least two features from a group of features consisting of an indication of a data ingestion method of the organization, data indicating a total number of members of the online service mapped to the profile of the organization, location data of the organization, an industry type of the organization, an organization type, data indicating a level of user engagement with the profile of the organization, an advertising metric, an indication of whether the organization has an account with another online service, and data indicating an age of the organization.

4. The computer-implemented method of claim 1, wherein the performing the function of the online service using the generated size data comprises storing, in a database, the generated size data in association with the profile of the organization.

5. The computer-implemented method of claim 1, wherein the performing the function of the online service using the generated size data comprises searching the online service for profiles of organizations that satisfy search criteria including at least a size criteria, the searching comprising determining whether the generated size data satisfies the size criteria of the search criteria.

6. The computer-implemented method of claim 5, further comprising receiving a search request including the search criteria, wherein the generating of the size data and the searching of the online service are performed based on the receiving of the search request.

7. The computer-implemented method of claim 1, further comprising:
transmitting a verification request to a computing device of a user associated with the organization, the verification request comprising the generated size data and a request for feedback regarding accuracy of the generated size data;
receiving, from the computing device, feedback regarding the accuracy of the generated size data; and
modifying the inference model based on the received feedback.

8. The computer-implemented method of claim 1, wherein the online service comprises a social networking service.

9. A system comprising:
at least one processor; and
a non-transitory machine-readable medium embodying a set of instructions that, when executed by the at least one processor, cause the at least one processor to perform operations, the operations comprising:
detecting a lack of size data for a profile of an organization on an online service, the size data identifying a size of the organization;
based on the detecting of the lack of size data for the profile of the organization, generating the size data based on an inference model and at least two attributes of the organization; and
performing a function of the online service using the generated size data.

10. The system of claim 9, wherein the operations further comprise:
retrieving instances of attributes for a plurality of organization profiles on the online service;
for each one of the plurality of organization profiles, generating a predicted size data using the inference model;
for each one of the plurality of organization profiles, retrieving a control size data; and
using a machine learning algorithm to modify the inference model based on a comparison of the corresponding predicted size data of the plurality of organization profiles with the corresponding control size data of the plurality of organization profiles.

11. The system of claim 9, wherein the size data comprises a classification of a total number of members of the organization.

12. The system of claim 9, wherein the at least two attributes comprise at least two features from a group of features consisting of an indication of a data ingestion method of the organization, data indicating a total number of members of the online service mapped to the profile of the organization, location data of the organization, an industry type of the organization, an organization type, data indicating a level of user engagement with the profile of the organization, an advertising metric, an indication of whether the organization has an account with another online service, and data indicating an age of the organization.

13. The system of claim 9, wherein the operations further comprise:
retrieving instances of attributes for a plurality of organization profiles on the online service;
for each one of the plurality of organization profiles, generating a predicted size data using the inference model;
for each one of the plurality of organization profiles, retrieving a control size data; and
using a machine learning algorithm to modify the inference model based on a comparison of the corresponding predicted size data of the plurality of organization profiles with the corresponding control size data of the plurality of organization profiles.

14. The system of claim 9, wherein the performing the function of the online service using the generated size data comprises storing, in a database, the generated size data in association with the profile of the organization.

15. The system of claim 9, wherein the performing the function of the online service using the generated size data comprises searching the online service for profiles of organizations that satisfy search criteria including at least a size criteria, the searching comprising determining whether the generated size data satisfies the size criteria of the search criteria.

16. The system of claim 15, wherein the operations further comprise receiving a search request including the search criteria, wherein the generating of the size data and the searching of the online service are performed based on the receiving of the search request.

17. The system of claim 9, wherein the operations further comprise:
transmitting a verification request to a computing device of a user associated with the organization, the verification request comprising the generated size data and a request for feedback regarding accuracy of the generated size data;
receiving, from the computing device, feedback regarding the accuracy of the generated size data; and
modifying the inference model based on the received feedback.

18. The system of claim 9, wherein the online service comprises a social networking service.

19. A non-transitory machine-readable medium embodying a set of instructions that, when executed by a processor, cause the processor to perform operations, the operations comprising:
detecting a lack of size data for a profile of an organization on an online service, the size data identifying a size of the organization;
based on the detecting of the lack of size data for the profile of the organization, generating the size data based on an inference model and at least two attributes of the organization; and
performing a function of the online service using the generated size data.

20. The non-transitory machine-readable medium of claim 19, wherein the operations further comprise:
retrieving instances of attributes for a plurality of organization profiles on the online service;
for each one of the plurality of organization profiles, generating a predicted size data using the inference model;
for each one of the plurality of organization profiles, retrieving a control size data; and
using a machine learning algorithm to modify the inference model based on a comparison of the corresponding predicted size data of the plurality of organization profiles with the corresponding control size data of the plurality of organization profiles.
